(19) United States
(12) Patent Application Publication
(10) Pub. No.: US 2026/0048513 A1
(43) Pub. Date: Feb. 19, 2026

(54) CARE ROBOT PROVIDING CARE SERVICE

(71) Applicant: ROBOCARE CO., LTD., Seongnam-si (KR)

(72) Inventors: Deok Won LEE, Seongnam-si (KR); Kook Sung JUN, Seongnam-si Gyeonggi-do (KR); Won Jun LEE, Seongnam-si (KR)

(21) Appl. No.: 19/369,428

(22) Filed: Oct. 27, 2025

Related U.S. Application Data
(63) Continuation of application No. PCT/KR2024/010807, filed on Jul. 25, 2024.

(30) Foreign Application Priority Data
May 3, 2024 (KR) 10-2024-0058876

(51) Int. Cl. B25J 11/00; B25J 9/16

(52) U.S. Cl. CPC B25J 11/0005; B25J 9/1697; B25J 11/008

(57) ABSTRACT

A care robot according to an embodiment of the present disclosure includes: at least one sensor; a memory configured to store instructions; and a processor operably connected to the memory and configured to execute the instructions. The processor is configured to: acquire robot-collected information related to a user by using the sensor; generate a prompt based on the robot-collected information and transmit the generated prompt to a language model; determine a care service to be provided to the user based on an output received from the language model; and control components of the care robot to perform the determined care service.

### TECHNICAL FIELD

The present disclosure relates to a care robot that is configured to collect information from a user and provide a care service to the user based on the collected information.

### BACKGROUND

In an aging society, care robots are robotic technologies designed for elderly individuals, persons with disabilities, or others requiring special care. Such care robots provide various services, including assistance with daily tasks, health monitoring, and emotional support, thereby contributing to the improvement of a user's quality of life. While care robots perform an important role in making a user's life more convenient and safer, conventional care robots are limited in their ability to provide customized services that fully address individual needs and circumstances.

Artificial intelligence (AI) technologies, particularly interactive AI and natural language processing, play a key role in enhancing the interaction between a user and a robot. Such technologies enable the robot to understand linguistic input from the user and to generate appropriate responses, thereby making communication more natural and allowing deeper interaction. For example, the robot can recognize the user's emotions and provide corresponding responses, which is important for supporting the user's emotional needs.

However, integration of such advanced interactive functions into a robot involves various technical challenges. First, powerful data processing capabilities are required to effectively process and interpret complex data generated from diverse users and environments. Further, dynamic decision-making algorithms are required to appropriately adapt and respond to real-time changes in the user's condition or environment. To this end, advanced algorithms and machine learning models need to be incorporated into a robot system, which may result in an increase in the design and manufacturing costs of the robot.

In recent years, significant advances have been made in Large Language Model (LLM) technology, and attempts to integrate such technology into a robotic system have been increasing. An LLM is capable of performing complex language understanding and generation tasks based on natural language data. Incorporating the LLM into robot technology can make communication between the robot and the user more natural and effective. In particular, interaction using the LLM plays an important role in enabling the robot to more accurately identify the user's needs and to provide appropriate responses.

For effective utilization of the LLM, the quality of prompts provided as input is important. A prompt is a question or command provided by the robot to the LLM and determines the context and accuracy of the output generated by the LLM. Accordingly, to generate appropriate and accurate prompts, the robot requires the capability to comprehensively collect and analyze various types of user information, including not only spoken words but also activities, environmental conditions, and emotional states.

However, conventional robots have difficulty in collecting various types of user-related information. Even when such information is collected, there are challenges in processing the information into a format suitable for input into a language model such as an LLM.

### DISCLOSURE OF THE INVENTION

### Problems to be Solved by the Invention

The present disclosure is conceived to provide a care robot configured to collect user-related information and determine care services required by a user based on a language model.

Also, the present disclosure is conceived to provide a care robot configured to collect various types of information from a user, enabling a language model to more accurately determine the user's situation.

Further, the present disclosure is conceived to provide a care robot capable of controlling a timing at which information collected by the robot is input into a language model, thereby suppressing cost increases resulting from frequent use of the language model.

However, the problems to be solved by the present disclosure are not limited to the above-described problems. There may be other problems to be solved by the present disclosure.

### Means for Solving the Problems

As a means for achieving the above-described technical problems, an aspect of the present disclosure provides a care robot including: at least one sensor; a memory configured to store instructions; and a processor operably connected to the memory and configured to execute the instructions. The processor is configured to: acquire robot-collected information related to a user by using the sensor; generate a prompt based on the robot-collected information and transmit the generated prompt to a language model; determine a care service to be provided to the user based on an output received from the language model; and control components of the care robot to perform the determined care service.

The above-described aspects are provided by way of illustration only and should not be construed as liming the present disclosure. Besides the above-described embodiments, there may be additional embodiments described in the accompanying drawings and the detailed description.

### Effects of the Invention

According to any one of the above-described means for solving the problems of the present disclosure, the present disclosure can provide a care robot configured to collect user-related information and determine care services required by a user based on a language model.

The present disclosure enables the collection of various types of information from the user so that the language model can more accurately determine the user's situation.

The present disclosure has the effect of suppressing cost increases resulting from frequent use of the language model by controlling a timing at which information collected by the robot is input into the language model.

### BRIEF DESCRIPTION OF THE DRAWINGS

FIG. 1 is a configuration view of a care robot and a care system according to an embodiment of the present disclosure.

FIG. 2 is a configuration view of the care robot according to an embodiment of the present disclosure.

FIG. 3 to FIG. 5 are diagrams illustrating a process of generating robot-collected information according to an embodiment of the present disclosure.

FIG. 6 and FIG. 7 are diagrams illustrating a process of moving the robot to generate the robot-collected information according to an embodiment of the present disclosure.

FIG. 8 to FIG. 11 are diagrams illustrating a process of generating a prompt for input into a language model based on collected information according to an embodiment of the present disclosure.

### BEST MODE FOR CARRYING OUT THE INVENTION

Hereafter, example embodiments will be described in detail with reference to the accompanying drawings so that the present disclosure may be readily implemented by those skilled in the art. However, it is to be noted that the present disclosure is not limited to the example embodiments but can be embodied in various other ways. In the drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected” another element and an element being “electronically connected” to another element via another element. Further, it is to be understood that the terms “comprises,” “includes,” “comprising,” and/or “including” means that one or more other components, steps, operations, and/or elements are not excluded from the described and recited systems, devices, apparatuses, and methods unless context dictates otherwise; and is not intended to preclude the possibility that one or more other components, steps, operations, parts, or combinations thereof may exist or may be added.

Throughout this document, the term “unit” may refer to a unit implemented by hardware, software, and/or a combination thereof. As examples only, one unit may be implemented by two or more pieces of hardware or two or more units may be implemented by one piece of hardware.

Throughout this document, a part of an operation or function described as being carried out by a terminal or device may be implemented or executed by a device connected to the terminal or device. Likewise, a part of an operation or function described as being implemented or executed by a device may be so implemented or executed by a terminal or device connected to the device.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality.

Processors are considered processing circuitry or circuitry as they include transistors and other circuitry therein. In the disclosure, the circuitry, units, or means are hardware that carry out or are programmed to perform the recited functionality.

The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

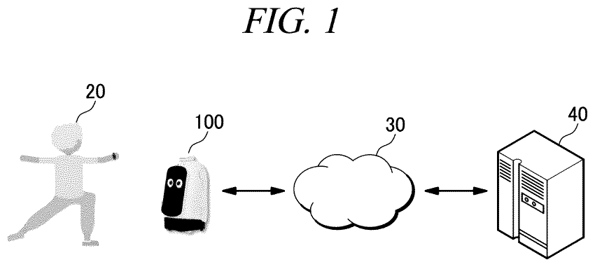

FIG. 1 is a configuration view of a care robot 100 and a care system according to an embodiment of the present disclosure.

Referring to FIG. 1, the care system may include the care robot 100 and a server 40 that are configured to provide a care service to a user 20.

The care robot 100 illustrated in FIG. 1 may be connected to the server 40 via a network 30. As shown in FIG. 1, the care robot 100 and the server 40 may be connected to the network 30 simultaneously or with a time interval. The network 30 refers to a connection structure that enables information exchange between nodes, such as devices and servers, and includes LAN (Local Area Network), WAN (Wide Area Network), Internet (WWW: World Wide Web), a wired or wireless data communication network, a telecommunication network, a wired or wireless television network, and the like. Examples of the wireless data communication network may include 3G, 4G, 5G, 3GPP (3rd Generation Partnership Project), LTE (Long Term Evolution), WIMAX (World Interoperability for Microwave Access), Wi-Fi, Bluetooth communication, infrared communication, ultrasonic communication, VLC (Visible Light Communication), LiFi, and the like, but may not be limited thereto.

The care robot 100 may be a robot equipped with its own means of mobility, and may include a camera for imaging the user 20, a microphone for receiving sounds input from the user, a display for presenting information to the user, and a speaker for outputting sounds to the user. In addition to the camera and the microphone, the care robot 100 may further include various sensors configured to detect surrounding conditions, such as temperature, humidity, illuminance, and pressure. The care robot 100 may also include an integrated controller configured to control the above-described devices. The integrated controller may include a memory and a processor, thereby functioning as a device having computational processing capability.

In an embodiment of the present disclosure, the camera of the care robot 100 may image an object to generate image type information. For example, an RGB (Red Green Blue) camera configured to generate pixel images having RGB properties may be used. The camera may also be a depth camera that provides distance information of an object or an infrared camera capable of capturing images in dark environments. The camera may perform still photography to generate a single image of the user 20, or may perform video recording to generate a video composed of a plurality of frames.

The memory may be a device configured to store information, and may include various types of memories, such as a high-speed random access memory, a magnetic disk storage device, a flash memory device, and other non-volatile solid-state memory devices. In the care robot 100, the memory may be implemented in the form of a database.

The care robot 100 may generate a prompt to be input into a language model based on information collected from the user 20, determine a care service to be provided to the user based on an output from the language model, and control components of the care robot 100 to provide the determined care service to the user. A more detailed description thereof will be provided below.

The user 20 may be a person who receives care services from the care robot 100, and may typically refer to a patient or an elderly person who has difficulty in moving. However, the user 20 is not limited thereto and may include various persons who need to use the care robot 100.

The server 40 may include a memory in which a plurality of modules is stored, a processor connected to the memory and configured to respond to the plurality of modules and to process service information provided to the care robot 100 or action information for controlling the service information, a communication means, and a user interface (UI) display means.

In the present disclosure, the server 40 may correspond to an external server capable of operating a language model. The information processed by the server 40 may include robot-collected information, IoT-collected information, cloud-collected information, and available service information of the care robot 100. Such information may be converted into service information or action information needed to instruct and coordinate the behavior of the care robot 100.

The care robot 100 may be linked to an external server including a cloud-based language model via the network 30. The external server may perform complex natural language processing tasks, and may generate appropriate linguistic responses based on data received from the care robot 100. The care robot 100 may utilize the generated responses to perform interactions with the user more naturally and effectively. The language model of the server 40 may provide the care robot 100, in text form, with information on the user 20's situation and types of care services to be provided by the care robot 100 to the user, in response to data input as prompts from the care robot 100. To this end, the server 40 may analyze and process data generated from the plurality of modules. In this process, the communication means of the server 40 may enable continuous data exchange with the care robot 100, and the UI display means may be designed to allow the user or administrator to monitor the server's status and perform necessary operations.

Such a structure ensures a smooth flow of information between the server 40 and the external server and enables the provision of customized care services to the user through complex data processing operations and response generation processes.

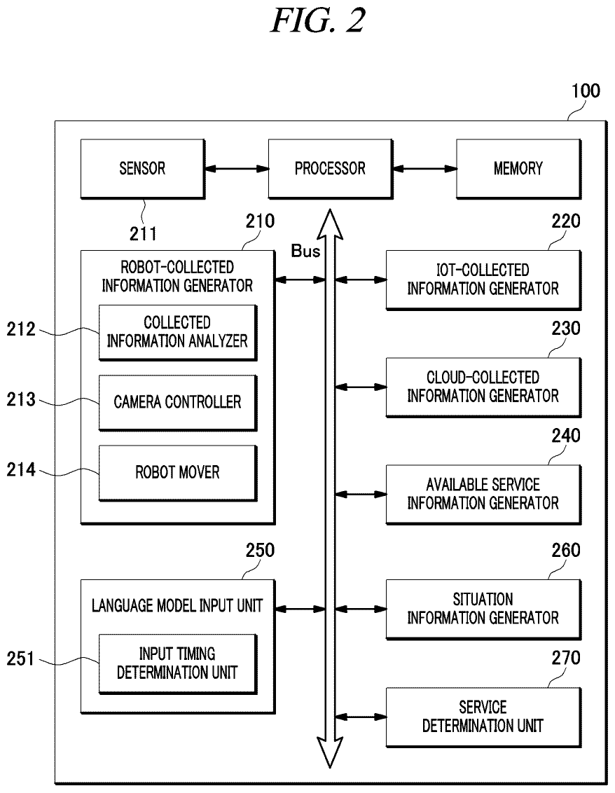

FIG. 2 is a configuration view of the care robot 100 according to an embodiment of the present disclosure.

Referring to FIG. 2, the care robot 100 may include a sensor 211, a robot-collected information generator 210, an IoT (Internet of Things)-collected information generator 220, a cloud-collected information generator 230, an available service information generator 240, a language model input unit 250, a situation information generator 260, and a service determination unit 270.

The robot-collected information generator 210 may include a collected information analyzer 212, a camera controller 213 and a robot mover 214. Further, the language model input unit 250 may include an input timing determination unit 251.

The robot-collected information generator 210, the IoT-collected information generator 220, the cloud-collected information generator 230, the available service information generator 240, the language model input unit 250, the situation information generator 260, and the service determination unit 270 shown in FIG. 2 may be logical components separated to describe the functional features of the present disclosure. The functional operations of these components (“units”) described throughout the whole document may be specifically implemented by the processor of the integrated controller. This is achieved by executing one or more computer-executable instructions stored in the memory, including interactions with specific hardware components.

More specifically, the care robot 100 may include the robot-collected information generator 210, the language model input unit 250, and the service determination unit 270. The robot-collected information generator 210 is configured to generate robot-collected information related to the user through the sensor 211 including at least one sensing device installed in the care robot 100. The language model input unit 250 is configured to generate a prompt based on the robot-collected information and input the generated prompt into a language model. The service determination unit 270 is configured to determine a care service to be provided to the user based on an output from the language model.

The sensor 211 including a camera configured to capture images of the user, and the collected information analyzer 212 configured to analyze sensing information generated by the sensor 211 to generate the robot-collected information.

The robot-collected information generator 210 may include the camera controller 213 configured to control at least one of vertical rotation, horizontal rotation, and height adjustment of the camera, and the robot mover 214 configured to move the care robot 100 to change its capture location.

The care robot 100 may further include the IoT-collected information generator 220 configured to generate IoT-collected information based on information collected from IoT devices connected to the care robot 100, and the language model input unit 250 may be configured to generate a prompt based on the robot-collected information and the IoT-collected information.

The care robot 100 may further include the cloud-collected information generator 230 configured to generate cloud-collected information from a cloud in which at least one of profile information of the user and pattern information on the user's daily patterns is stored, and the language model input unit 250 may be configured to generate the prompt based on the robot-collected information and the cloud-collected information.

The care robot 100 may further include the available service information generator 240 configured to generate available service information including a list of care services that can be provided to the user by the care robot 100, and the language model input unit 250 may be configured to generate the prompt based on the robot-collected information and the available service information.

The language model input unit 250 may include the input timing determination unit 251 configured to determine an input timing at which the generated prompt is to be input into the language model, and the language model input unit 250 may input the prompt into the language model according to the determined input timing.

The care robot 100 may further include the situation information generator 260 configured to generate situation information about the user's surrounding conditions based on the robot-collected information.

In addition to the above-described components, the care robot 100 may further include various components configured to check the user's state and provide appropriate care services.

For example, the care robot 100 may include a display configured to present services provided to the user 20 and a speaker configured to output sounds and voice messages generated while the services are provided to the user 20.

The display serves as a type of liquid crystal display, and may output one or more of text, an image, or a video containing predetermined information. Herein, the predetermined information may include status information of the care robot 100, such as communication signal strength information, remaining battery information, or wireless Internet ON/OFF information. The display may present content related to services to be described below, and may display, in text form, voice output through the speaker. For example, when the care robot 100 provides voice corresponding to service-related content to the user while issuing an operation instruction, text such as “Raise your right arm higher” may be displayed on the display. Further, as will be described later, during a process in which the care robot 100 performs user identification of the user 20, the display may output text, such as “Please come closer” or “Please face me directly”, to instruct the user to perform actions required for the identification.

The display may output text by repeating a single type of information described above, by alternating between a plurality of types, or by outputting specific information by default. For example, status information of the care robot 100, such as communication signal strength information, remaining battery information, or wireless Internet ON/OFF information, may be continuously output as small text at the top or bottom of the display while other types of information may be alternately output.

As described above, the display may output one or more of images or videos. In this case, to enhance visibility, it is preferable for the display to be implemented as a large, high-resolution liquid crystal display, rather than one that only outputs text. As will be described later, the display may be configured on an outer surface or inside the care robot, or may be provided as a separate device external to the care robot 100.

Meanwhile, the display may be positioned on the front side of the care robot 100. Thus, the user 20 facing the front of the care robot 100 can view the content presented on the display together with the care robot 100.

The speaker may output various sounds including voice. Herein, the voice is auditory information output by the care robot 100 for interaction with the user. The type of voice can be set by using a media-specific application installed on the user 20's device (not shown) or by directly controlling the care robot 100.

For example, the type of voice output through the speaker may be selected from various voices, such as a male voice, a female voice, an adult's voice, and a child's voice, and the language may also be selected, such as Korean, English, Japanese, and French.

The speaker not only outputs voice but also functions as a typical speaker for general sound output. For example, if the user 20 wants to listen to music through the care robot 100, the music may be output through the speaker. If a video is displayed on the display, sound synchronized with the video may be output through the speaker.

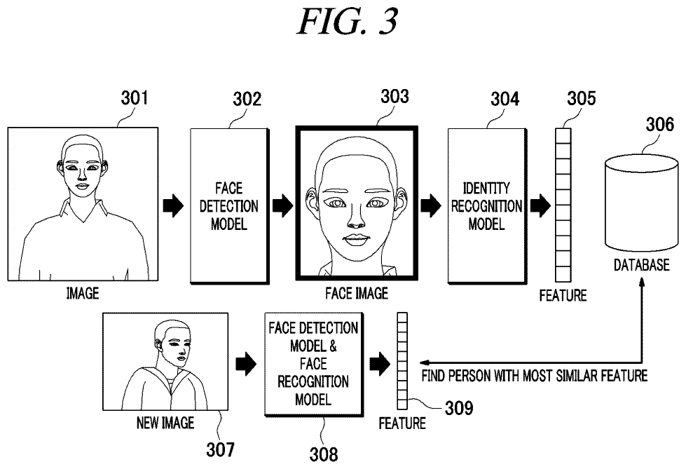

FIG. 3 to FIG. 5 are diagrams illustrating a process of generating robot-collected information according to an embodiment of the present disclosure.

The care robot 100 may capture at least a part of the user 20's body (e.g., the face) through a camera included in the sensor 211 of the robot-collected information generator 210.

The care robot 100 may detect a face within an image being captured by the camera through a face detection model. The face detection model may be used in a similar way to the above-described object detection mode. Unlike the object detection model, which detects a specific object in an image, the face detection model may identify the location of a face in an image and generate a corresponding bounding box. As the face detection model, a convolutional neural network (CNN)-based detection model may be applied, and object detection algorithms, such as RCNN, Fast RCNN, YOLO, Single Shot Detector (SSD), Retina-Net, and Pyramid Net, may be used.

In order to improve the accuracy of results, information about the user's height, which is either previously input into the face detection model or estimated through a pose estimation model, may be provided to the care robot. Accordingly, the care robot 100 may vertically rotate the camera toward the user's face to accurately recognize the face of the standing user even at a close distance. A more detailed description thereof will be provided below.

FIG. 3 is a diagram illustrating an identity recognition model 304 configured to apply a face detection model 302 to an image 301 and recognize the user's identity from a face image 303 generated based on the location of the face determined by the face detection model 302.

The identity recognition model 304 may extract features 305 from the face image 303 in the bounding box and store them in a database 306. Then, the identity recognition model 304 may perform identification based on the user's face image by comparing the features previously stored in the database with features 309 extracted from a new image 307 by applying the face detection model and the identity recognition model. As the identity recognition model 304, a CNN-based model may be applied, and algorithms, such as VGG-Face, FaceNet, OpenFace, DeepFace, and ArcFace, may be used.

Referring to FIG. 3, the face detection model 302 applies the face detection model 302 to the image of a person to generate a bounding box around a person's face in the image 301 and extract the face image 303, which is then input into the identity recognition model 304 to extract its features 305. The extracted features 305 are stored in the database 306. Thereafter, when the new image 307 is input, the features 309 are extracted by applying the above-described face detection model and identity recognition model 308 and then compared and matched with the features previously stored in the database 306 to recognize the identity.

To improve the accuracy of the results, the identity recognition model 304 may provide voice guidance to induce the user to face the camera of the care robot 100. Accordingly, the care robot 100 may generate a front image of the user 20's face to recognize the user's identity more accurately. A face orientation recognition model, which will be described later, may confirm whether the user's face is facing the camera based on its result data.

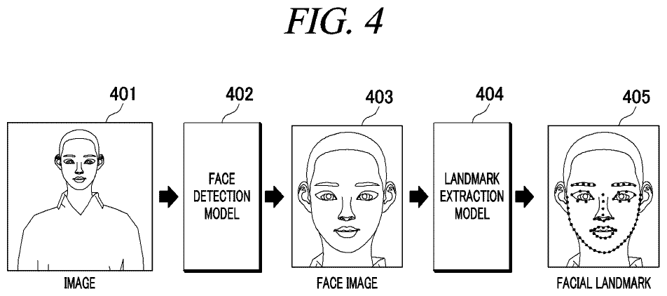

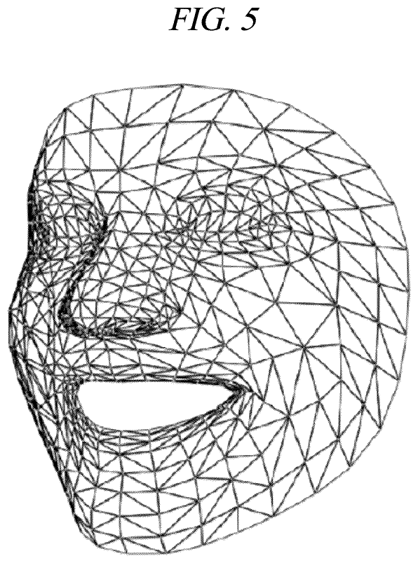

FIG. 4 and FIG. 5 are diagrams illustrating the face orientation recognition model configured to recognize the user's face orientation from a face image generated based on the determined face location.

First, based on an image 401 of the user, a face detection model 402 may extract a face image 403 of the user 20. Then, a landmark extraction model 404 may extract facial landmarks 405 from the face image 403. A convolutional neural network (CNN) may be used in this process. The face orientation recognition model may output the orientation of the face based on the positions of the eyes and nose as well as the facial contours.

Referring to FIG. 4, the face detection model 402 generates a bounding box for the face image 403 from the input image 401, and the face image 403 is input into the landmark extraction model 404 to extract the facial landmarks 405.

Referring to FIG. 5, the orientation of the face is output based on the extracted facial landmarks.

The robot-collected information generator 210 of the care robot 100 may include the collected information analyzer 212 configured to analyze information collected from the sensor 211. The sensor 211 may include various sensing devices including a camera. As described above with reference to FIG. 3 to FIG. 5, the user's face may be captured through the camera of the sensor 211, and the user's identity may be verified based on the captured face image of the user.

The camera may capture at least one of the user 20's face, walking scene, body shape, and clothing.

The collected information analyzer 212 may analyze images captured by the camera to generate the robot-collected information.

To this end, images of the user 20's face, walking scene, body shape, and clothing, or features derived from such images may be matched with the user 20 and stored in a database in which the care robot 100 is installed, or in another database accessible by the care robot 100 through a wired or wireless connection.

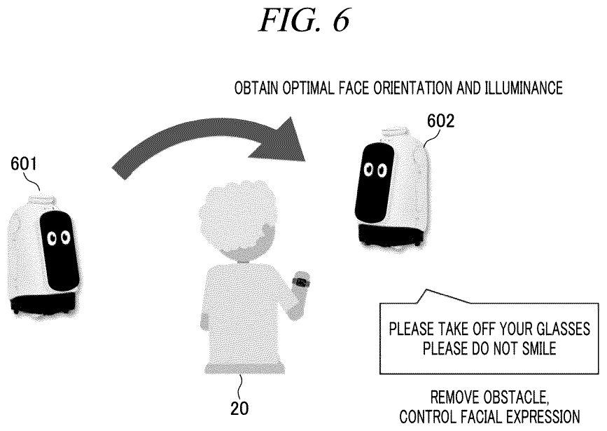

As illustrated in the example of FIG. 6, the care robot 100 may move around the user 20 to change the camera capture direction. The care robot 100 may also provide messages such as “Please walk in front of me” or “Please bring your face closer to the camera” to the user 20 through voice or text output.

More specifically, the care robot 100 may include the sensor 211 and the collected information analyzer 212 configured to recognize and analyze various physical characteristics and activities of the user 20. The camera in the sensor 211 serves as the primary means of collecting information related to the user by capturing the user's face, walking scene, body shape, clothing, and the like. The images captured by the camera may play a key role in analyzing the user's identity.

The care robot 100 may capture images of the user 20 walking. The care robot 100 may analyze the user's walking speed, gait pattern, and body movements from the captured images of walking scenes. The care robot 100 may extract features of the gait pattern through an activity analysis algorithm from the captured images of walking scenes. This is based on the fact that each user has a unique walking style. The care robot 100 may analyze user information by comparing the extracted features with gait patterns stored in the database.

The care robot 100 may capture the user 20's overall body shape and analyze the silhouette, body proportion, and size. The care robot 100 may extract features of the body shape through a body-shape recognition algorithm, and may identify the user or analyze the type of clothing worn by the user based on the extracted features.

The care robot 100 may capture the color, pattern, and style of clothing worn by the user 20. Thereafter, the care robot 100 may use a clothing recognition algorithm to derive features from the captured clothing images. The care robot 100 may identify that the user is wearing specific clothing at a specific time based on the features of the clothing.

The collected information analyzer 212 may analyze the captured images to generate the robot-collected information. Known image analysis algorithms may be used as the above-described face recognition model, activity analysis algorithm, body-shape recognition algorithm, and clothing recognition algorithm. These algorithms or models may be executed by the collected information analyzer 212 of the care robot 100. During the analysis of the collected information, comparative analysis may be performed between the user's information stored in a database within the care robot 100 or in an external database connected to the robot.

The information analyzed by the collected information analyzer 212 may be used for generating prompts of the language model input unit 250, as described below.

The sensor 211 may include a microphone for recognizing the voice of the user 20.

The collected information analyzer 212 may generate the robot-collected information based on sensing information generated by the sensor 211.

The microphone may receive sounds input from the user or from the surroundings of the user to obtain the user's voice and analyze the characteristics of a specific user's voice through voice recognition technology. The collected information analyzer 212 may analyze unique characteristics of the user's voice, such as pitch, tone, and stress, based on the sounds input through the microphone, and may convert the user's voice or speech into text. In this process, a Speech-to-text (STT) algorithm may be used.

Such various components of the sensor 211 may be installed in the care robot 100 to collect information about the user in various environments and situations, thereby contributing to the generation of specific robot-collected information.

FIG. 6 illustrates an example in which the care robot captures an image of the user 20 from a first position 601 and then moves to a second position 602 to capture another image of the user 20 in order to perform a more accurate situation analysis based on the captured images. The care robot 100 may provide messages, such as “Please take off your glasses” or “Please do not smile” to the user 20 through voice or text output. This allows the robot to induce certain activities from the user 20 and to more accurately derive robot-collected information.

In order for the care robot 100 to more accurately recognize the user's condition or surrounding situation and capture images, the camera controller 213 or the robot mover 214 may be used to change the location or capture angle of the camera.

As described above, the robot-collected information generator 210 may include the camera controller 213 and the robot mover 214. The camera controller 213 is configured to control at least one of vertical rotation, horizontal rotation, and height adjustment of the camera. The robot mover 214 is configured to move the care robot 100 to change a capture location of the care robot 100.

The camera controller 213 may include a tilting unit (not shown) for rotating the camera in a vertical direction, a panning unit (not shown) for rotating the camera in a horizontal direction, and a lifting unit (not shown) for adjusting the height of the camera. The camera controller 213 may change the capture direction of the camera. The tilting unit, panning unit, and lifting unit may be directly connected to the camera, but they may also be arranged to be physically spaced apart from the camera depending on the shape or size of the care robot 100. At least one of the functions of the tilting unit, panning unit, and lifting unit may be replaced by another device configured to rotate or elevate the care robot 100.

If a pose recognition rate of the care robot 100 is equal to or less than a predetermined threshold, the robot-collected information generator 210 may improve the pose recognition rate by controlling the camera controller 213, which may change the capture direction of the camera by controlling at least one of the tilting unit, the panning unit, and the lifting unit.

The robot mover 214 may include components configured to move the care robot 100, and may thus change the location or rotate the care robot 100. Accordingly, the camera may capture an image of the user 20 from the changed location of the care robot 100 to improve the pose recognition rate in the process of generating hand gesture information or full-body pose information. Further, the robot mover 214 may move the care robot 100 to follow the user 20 as needed.

The robot mover 214 may provide a means for enabling the care robot 100 to move within a specific space according to movement commands from a control device. More specifically, the robot mover 214 may include a motor and a plurality of wheels, which are combined to perform functions of driving, steering, and rotating the care robot 100.

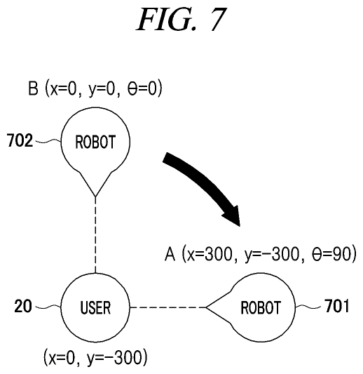

FIG. 7 illustrates an example of representing, on a virtual map, the relative positions of the user 20 and the care robot shown in FIG. 6. The care robot may calculate coordinate information between a destination B and a starting point A on the virtual map, and an angle (Θ) needed to face the user 20 after arriving at the destination. Thereafter, the care robot may move to coordinate information 702 of the destination. After the care robot arrives at the destination, it may rotate by the angle (Θ) to capture an image of the user 20.

In the example shown in FIG. 7, an care robot 701 located at a position A may have coordinate values (0,0) corresponding to the position A on the virtual map, and may move to a position B after receiving coordinate values (−300, 300) of the position B. Thereafter, the care robot 701 may rotate by an input rotation angle (Θ) to capture an image of the user 20. During this process, coordinate values (e.g., −300, 0) of the user 20 and coordinate values of the care robot may be continuously updated by a position tracker.

In another embodiment of the present disclosure, unlike the above-described case, the care robot may generate a virtual map solely based on imaging information generated by a vision sensor without relying on LiDAR, and may control movements of an exercise support service-providing robot. To this end, Visual SLAM (Simultaneous Localization and Mapping) technology may be used.

The robot-collected information may refer to information directly collected by the care robot 100 and supplied to the language model input unit 250 in the form of images or text. The language model input unit 250 may include, in the robot-collected information, images captured by the camera of the sensor 211. Further, the language model input unit 250 may convert user-related information generated by the collected information analyzer 212 into text and generate a prompt.

The robot-collected information may include analyzed biometric information of the user (such as, heart rate, pulse, blood pressure, respiration, and stress), vision information (such as, the user's identity, facial expressions, posture, activity, and surrounding objects) generated by analyzing images captured by the camera, spatial information of the location of the care robot 100 (such as, location on a 3D map), content information (such as, game scores and number of game plays) provided by the care robot 100, conversation information (such as, health information, emotion information, and hobby information obtained from conversations) generated by analyzing conversation history between the user and the care robot 100, schedule information of the user (such as, medication, meals, outings, and other schedules), health information of the user (such as, personal diseases, sleep information, gait analysis information, and pain areas), and other information (such as, weather, news, and notices).

The language model input unit 250 of the care robot 100 may convert the robot-collected information generated as described above into text and generate a prompt.

For example, the language model input unit 250 may generate text in the form of “Location: living room, Facial expression: pain, Posture: lying down, Surrounding object: water bottle, Health information: reported dizziness one hour ago” based on the robot-collected information, and may input the generated text into the prompt.

In another embodiment of the present disclosure, the language model input unit 250 may generate a prompt based on at least one of the robot-collected information, IoT-collected information, cloud-collected information, and available service information.

Meanwhile, the IoT-collected information generator 220 may generate IoT-collected information. The IoT-collected information generator 220 may generate the IoT-collected information based on information collected from IoT devices connected to the care robot 100.

More specifically, the care robot 100 may receive various types of information from IoT devices connected thereto via wired or wireless communication. The care robot 100 may be located near the IoT devices and connected thereto wirelessly via Bluetooth or infrared communication, or directly by wire. The care robot 100 may also receive information, via a network, from external IoT devices that exchange information with the server connected to the care robot 100.

Such IoT devices may include various smart electronics installed indoors (e.g., TVs, air conditioners, lighting devices, AI speakers, smartwatches, etc.), and each IoT device may provide the care robot 100 with various types of sensing information related to the user's activities or surrounding conditions (e.g., temperature, illuminance, weather, content being watched, or the user's usage history of IoT devices). The care robot 100 may process information received from connected IoT devices into text form to generate IoT-collected information. In this case, the generated IoT-collected information may include its source (generator), a corresponding label, and a numerical value. For example, the IoT-collected information converted into text may be generated as “Smart TV: currently watching channel 8; TV volume: 15; Viewing time: 20 minutes,” or as “Smart air conditioner: current room temperature: 20° C., Target room temperature: 15° C., Operation time: 30 minutes, Wind speed: maximum,” or as “Living-room temperature: 27° C., Living-room humidity: 50%, Fine dust: moderate, Air conditioner 1: off, Air purifier: on, Pulse: 120, Maximum blood pressure: 140.”

The cloud-collected information generator 230 may generate cloud-collected information. More specifically, the cloud-collected information generator 230 may generate the cloud-collected information from a cloud in which at least one of profile information of the user and pattern information on the user's daily patterns is stored.

The cloud-collected information generator 230 may include a pattern analysis model that, when activity information including the user's hourly activity history and information about a pattern generation period are input, outputs an expected activity of the user for the current time as expected pattern information.

The cloud-collected information may include the user's basic information (e.g., name, gender, age, date of birth, health status, family information, height, weight, etc.) and daily pattern information (e.g., events frequently occurring at specific times, periodically occurring events, sequentially occurring events, events occurring depending on environmental conditions or emotions, etc.).

Herein, the user's daily pattern information may be generated by extracting events according to specific rules, taking into account relationships among time, frequency, environment, emotion, and event, based on information acquired during a specific period (e.g., one month).

A first daily pattern may be derived by digitizing events that occur at specific times (e.g., waking up, sleeping, eating, exercising, watching TV, bathing, etc. —time and activity) and extracting daily patterns based on frequency (e.g., events occurring at least n times during a specific period).

A second daily pattern may be derived by digitizing time, activities, and events that occur at specific intervals (e.g., visiting the bathroom every two hours, exercising every three days, and visiting a hospital once a month) and extracting daily patterns based on frequency (e.g., events occurring at least n times during a specific period).

A third daily pattern may be derived by digitizing consecutive activities corresponding to sequentially occurring events (e.g., bathing after exercising, and visiting the bathroom after waking up) and extracting daily patterns based on frequency (e.g., events occurring at least n times during a specific period).

A fourth daily pattern may be derived by digitizing time, environment, and activities corresponding to events that occur depending on environmental conditions (e.g., folding laundry when the weather is good, eating jeon when it rains, and cancelling an outing when it snows) and extracting daily patterns based on frequency (e.g., events occurring at least n times during a specific period).

A fifth daily pattern may be derived by digitizing time, emotion, and activities corresponding to events that occur depending on the user's emotions (e.g., going for a walk at 3 p.m. when in a good mood, and going to bed one hour earlier than usual when feeling depressed) and extracting daily patterns based on frequency (e.g., events occurring at least n times during a specific period).

Herein, the specific period may vary depending on the pattern to be extracted. For example, for the first daily pattern, the specific period may be set to one month since similar tendencies appear monthly. For the fourth daily pattern, the specific period may be set to one year since tendencies differ from month to month.

The priorities of the respective daily patterns may be customized according to the user. For example, even if the user exercises every day at 3 p.m. (first daily pattern), when it rains at that time, the user goes to eat jeon (fourth daily pattern). As such, the information may be digitized such that when the probabilities of specific events overlap, the daily pattern is determined based on the event with the higher frequency.

As the user's activity or environment changes, the daily patterns may be continuously updated, and the daily pattern analysis model may be continuously optimized based thereon.

Such daily patterns may be extracted using rule-based methods or using AI such as machine learning. When AI is used, if the user's schedule information, current time, and a most recent event are input into AI, the event having the highest probability of occurrence at the present time may be output. The pattern analysis model that outputs an expected activity of the user for the current time as expected pattern information may be a model based on AI, such as machine learning.

The daily pattern information and the expected pattern information generated by the cloud-collected information generator 230 may be included in the cloud-collected information and used subsequently to generate a prompt.

The available service information generator 240 may generate available service information.

The available service information generator 240 may generate the available service information including a list of care services that can be provided to the user by the care robot 100.

The available service information may vary depending on the type, shape, size, and functions of the care robot 100, or on whether the care robot 100 is in a malfunction state. Further, the available service information may vary depending on the user's age, health, situation and current time, and the location or place of the care robot 100. That is, in addition to all care services that can be provided by the care robot 100, the available service information may include a list of services that can be provided by the care robot 100 to the user in the current situation.

For example, the list of services included in the available service information may include cognitive training, exercise assistance, games, emotional conversation, music and video playback content services, emergency response services, journaling, schedule alarms, meal reminders, medication reminders, security services, video calls, weather information services, educational content services, acquisition of biometric information, health management services, cleaning services, IoT control, and SNS browsing services.

The available service information may further include information on priorities among the care services that can be provided to the user, and the service determination unit 270 may determine a care service to be provided to the user based on an output from the language model and the priorities.

The available service information may include, in addition to a simple parallel list of services available to the user, priority information for determining which service is to be provided preferentially to the user.

For example, when the available service information includes a medication reminder service and a weather information service and the medication reminder service has a higher priority than the weather information service, the service determination unit 270 may determine that the medication reminder service is to be provided to the user in preference to the weather information service.

Meanwhile, the priority information is not necessarily preset for each care service, and may be configured to be provided differently according to the user's situation information.

For example, when a risk situation such as a fall is first priority and exercising in the living room at 3 p.m. is second priority, the service determination unit 270 may determine that a care service related to the first priority situation is to be provided preferentially.

In such cases, both a rule-based method and an AI-based method may be used to obtain the priority information.

The rule-based method may refer to generating priority information based on rules set by a human. For example, for a user with diabetes, the priority of meal reminders may be set high. As another example, for a user with obesity or hypertension, the priority of exercise may be set high. As yet another example, for an elderly user, recognition of and response to emergencies may be set as a top priority. As still another example, in an environment with many stairs, security and emergency recognition may be set as priorities.

The AI-based method may refer to generating optimal priority information customized for each space and individual user by allowing AI to determine priorities based on all information acquired by the care robot 100 (robot-collected information, IoT-collected information, cloud-collected information, and available service information). The priority information may be updated periodically and may also be updated whenever a situation determination is made. The AI may be training-based machine learning and may include a generative language model.

Meanwhile, the rule-based method and the AI-based method may be used together. That is, the rules set by a human may be preferentially reflected, and for situations not defined by the rules, information on priorities determined by AI may be used.

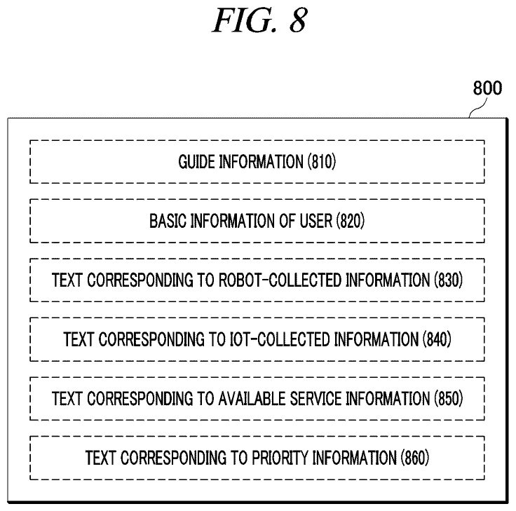

FIG. 8 to FIG. 11 are diagrams illustrating examples of screens displaying a process of generating a prompt for input into a language model based on collected information according to an embodiment of the present disclosure.

In the present disclosure, a prompt may refer to text information in a natural language format that is input into a language model. Further, with the recent development of generative language models, which support multimodal inputs, such as images, document files, audio files, and text, the prompt may include various types of information, such as images, audio, documents, and web links, and is not limited to text.

The language model used in the present disclosure may refer to an advanced generative model or a large language model. The language model of the present disclosure may be, for example, a ChatGPT-based model, such as GPT-3 or GPT-4, which are generative transformer networks developed by OpenAI, BERT (Bidirectional Encoder Representations from Transformers) developed by Google, ROBERTa (Robustly Optimized BERT approach) which is a variant of BERT developed by Facebook, or T5 (Text-to-Text Transfer Transformer) developed by Google.

Although these models adopt different architectures and training methods, they all have the capability to perform advanced natural language processing and exhibit excellent performance in understanding complex linguistic contexts and generating appropriate outputs.

The language model of the present disclosure has the capability to process multimodal data. The language model may receive various types of input data, such as text, images, and voice, and generate appropriate text or voice output based on the input. Such multimodal functionality not only enables more natural and effective interaction with the user, but also provides the care robot 100 with the ability to more accurately understand and respond to the user's requirements.

The language model is trained on large-scale datasets and incorporates extensive knowledge capable of responding to various linguistic situations. Through natural language understanding (NLU) and natural language generation (NLG) functions, the language model may generate human-like conversations and plays an important role in identifying the detailed needs of individuals requiring care and providing services appropriate thereto.

The language model of the present disclosure may be implemented as a cloud-based system installed and operated outside the care robot 100. Such a configuration enables fast and efficient execution of complex computation and data processing tasks by utilizing high-performance computing resources, and allows continuous improvement of the model's performance through ongoing updates and training. Since the language model is operated in the cloud, the care robot 100 may access the language model via a network to exchange data in real time and receive necessary support.

The language model provides extensive functions beyond simple text processing. In particular, its multimodal data processing capability greatly assists the robot in understanding not only the user's speech but also their nonverbal signals and environmental context. This serves to significantly improve the accuracy and efficiency of services required for user care.

The prompt is generated by the language model input unit 250, and may be generated based on at least one of the robot-collected information, the IoT-collected information, the cloud-collected information, and the available service information.

The prompt may be configured as multimodal data that may include images as well as text, thereby enabling the language model to generate richer and more contextually appropriate responses. For example, the prompt may include image data of the user's facial expression or surrounding environment, and, thus, the language model can respond more sensitively to the user's emotional state or needs.

The prompt may also include guide information. The guide information may specify a desired response format for the care robot 100, and may include specific instructions to assist the robot in determining service options executable by the robot. This information adjusts the responses generated by the language model to fit the operating context of the care robot. It also assists the robot in recommending the most suitable services based on the user's current needs and situation.

FIG. 8 illustrates an example of a screen displaying a prompt 800 generated by the language model input unit 250.

Referring to FIG. 8, the prompt 800 may include guide information 810, basic information 820 of the user, text 830 corresponding to the robot-collected information, text 840 corresponding to the IoT-collected information, text 850 corresponding to the available service information, and text 860 corresponding to the priority information. Each text may be generated by the language model input unit 250 based on the robot-collected information, the IoT-collected information, the available service information, and the priority information.

The prompt 800 may include, in a preface section, instruction text, such as “Based on the information below, determine the current situation and select the most appropriate service to be provided to the user. The response format is as follows.”

The guide information 810 may include text, such as “1. Situation assessment: response 2. Suitable service: response.”

The basic information 820 of the user may include text, such as “[Basic information] Name: Young-Hee Kim, Gender: female, Age: 72, Health status: diabetes.”

The text 830 corresponding to the robot-collected information may include text, such as “Living-room temperature: 27° C., Living-room humidity: 50%, Fine dust: moderate, Air conditioner 1: off, Air purifier: on, Shock sensor: shock detected, Pulse: 120, Maximum blood pressure: 140, Minimum blood pressure: 90.”

The text 850 corresponding to the available service information may include text, such as “cognitive training, exercise content, games, emotional conversation, music and video playback, emergency response, emergency call (119), journaling, schedule alarms, meal reminders, medication reminders, security, video calls, weather information, education, detailed-information acquisition, health management, cleaning, IoT control, SNS.”

The text 860 corresponding to the priority information may include text, such as “Priority 1: emergency response, emergency call (119), Priority 2: meal reminder, medication reminder, Priority 3: others.”

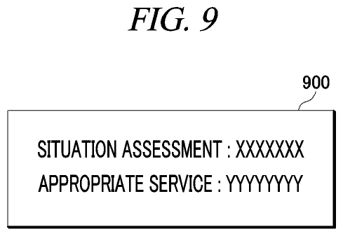

FIG. 9 illustrates an example response 900 generated by the language model in response to a prompt input from the care robot 100. The response of FIG. 9 exemplifies a response generated by the language model corresponding to the prompt of FIG. 8. As shown in FIG. 9, the language model may analyze the content of the prompt to analyze the user's situation in accordance with the instructions of the guide information 810, and may generate a response regarding which care service is to be provided.

The generated response 900 of FIG. 9 may include text, such as “Situation assessment: Young-Hee Kim (female, 72) is lying in the living room with a painful expression and reported dizziness one hour ago. Pulse is 120, maximum blood pressure is 140, and minimum blood pressure is 90, and the shock sensor detected a shock. This information suggests that Young-Hee Kim may be experiencing a serious health problem. Further, since she has diabetes, greater attention to her health condition is required. Suitable service: Emergency response and emergency call (119): The current situation has been assessed as an emergency. Her health condition, recent dizziness, high pulse and blood pressure, and detected shock indicate the need for immediate medical response. Therefore, the top priority is to call 119 immediately to request assistance from emergency responders.”

Subsequently, health management services for continuous monitoring and management may be required depending on the situation. Also, meal reminders and medication reminders for diabetes management may be important.

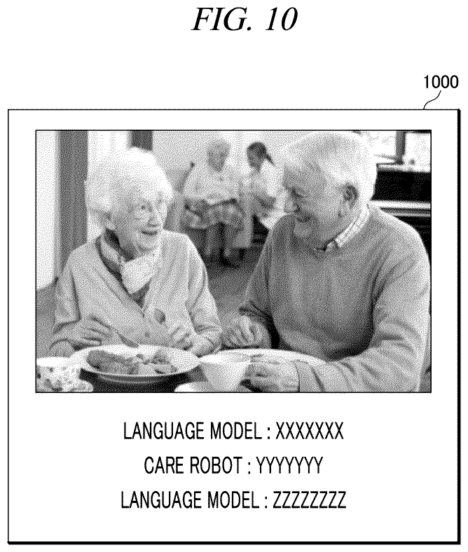

FIG. 10 illustrates an example response output from the language model when the care robot 100 inputs an image into the language mode.

Referring to FIG. 10, query content 1000 between the care robot 100 and the language model is illustrated.

In the example of FIG. 10, the query content 1000 may include text, such as “Language model: The photo shows two elderly individuals having a meal. On the left is an elderly woman with a scarf on her head, wearing a beige sweater and eating. On the right is an elderly man wearing a gray sweater and glasses, also eating. On the table, food is on plates as they dine. The woman appears to be conversing with the other person, and this appears to be inside a community center of a senior care facility. The overall atmosphere appears warm and quiet. Care robot: What food are they eating? Language model: The food shown appears to be a typical Western meal. On the plate, there is something that looks like fried potato pieces or rice; to the side are several pieces of carrot and shredded salad. In front of the elderly person is a drink that appears to be a soft drink or water. The photo shows the two elderly people having a meal and enjoying a pleasant conversation.”

When an image captured by the camera of the care robot 100 and guide information requesting analysis of the image are input together into the language model, the language model may analyze the image and generate responses regarding the situation of persons in the image, their clothing, arrangement of persons, and atmosphere.

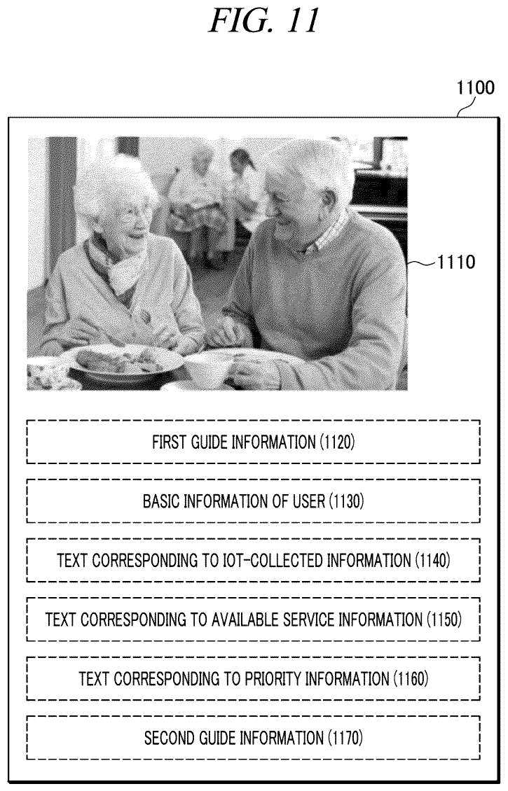

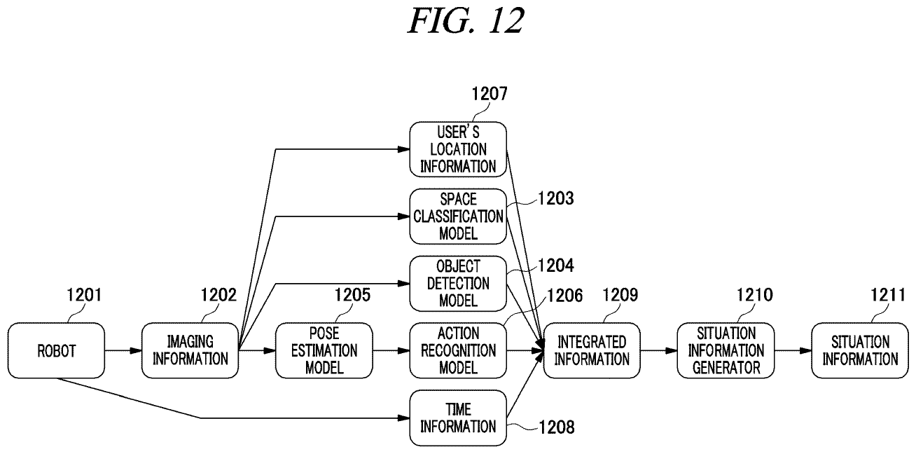

FIG. 11 illustrates a prompt 1100 generated according to an embodiment of the present disclosure. Referring to FIG. 11, the prompt 1100 may include image information 1110, first guide information 1120, basic information 1130 of the user, text 1140 corresponding to the IoT-collected information, text 1150 corresponding to the available service information, text 1160 corresponding to the priority information, and second guide information 1170.

Unlike FIG. 8, the example of FIG. 11 shows that the prompt 1100 includes the image information 1110 and the second guide information 1170. The image information 1110 may include images captured by the camera of the care robot 100. The second guide information 1170 may be configured as text preset by a designer or a user of the care robot 100.

In FIG. 11, the first guide information 1120 may include text, such as “Based on the information below, provide one case example, and select one service most suitable for the user. Also, refer to the guidelines. Format your response as follows: 1. Situation assessment: response 2. Available service: response 3. Include Details: response.”

The basic information 1130 of the user may include text, such as “Situation assessment: response, Name: Young-Hee Kim, Gender: female, Age: 72, Health status: diabetes.”

The text 1140 corresponding to the IoT-collected information may include text, such as “Smart device status information, Living-room temperature: 27° C., Living-room humidity: 50%, Message screen: unknown, Earphones: off, Shock detection status: off, Pulse detection: not detected, Pulse: 70, Maximum pulse: 100, Minimum pulse: 70.”

The text 1150 corresponding to the available service information may include text, such as “cognitive training, exercise content, games, emotional conversation, music and video playback, emergency response, emergency call (119), journaling, schedule alarms, meal reminders, medication reminders, security, video calls, weather information, education, detailed-information acquisition, health management, cleaning, IoT control, SNS.”

Further, the text 1160 corresponding to the priority information may include text, such as “Priority 1: emergency response, emergency call (119), Priority 2: meal reminder, medication reminder, Priority 3: others.”

The second guide information 1170 may include text such as, “Guidelines: If the person in the photo is determined to be eating, analyze the meal menu and present the composition of the meal. The goal is to provide a meal menu that matches the user's health status. For example, recommend low-sugar meals for diabetic patients. For emergency response, advise immediate first-aid methods and calling 119. After detecting an emergency, it is important to keep the user calm and safe while waiting for emergency responders to arrive. Also, set daily meal and medication reminders to ensure the user's safety and assist the user in taking medication at scheduled times. It is important to provide regular health check-ups and assessments by recording and analyzing conversations with the user through smart devices. Provide additional information on the meal menu, as needed, to assist the user in making better health decisions.”

The language model to which the prompt of FIG. 11 is input may be a multimodal language model configured to receive and analyze text and image data.

The care robot 100 may determine which images among a plurality of captured images are to be included in a prompt for input into the language model, without including all of the plurality of images.

The care robot 100 may select an image highly relevant to the situation or event from among a plurality of candidate input images. In this process, artificial intelligence mounted on the care robot 100 may be used. The care robot 100 may input candidate images into an AI model, and the AI model may output, as a result value, a digitized degree of event occurrence (e.g., in a range of 0.0 to 1.0). Thereafter, the image having the highest result value may be included in the prompt to be input into the language model.

Unlike the first guide information 1120, the second guide information 1170 may include more detailed guide information regarding the responses of the language model. In another embodiment of the present disclosure, the guide information may be used for initial fine-tuning of the language model, rather than being input in the prompt. In this case, the language model may be used without having to input the guide information into the prompt each time.

The language model input unit 250 may include the input timing determination unit 251 configured to generate a prompt and to determine a timing for inputting the generated prompt into the language model. Further, the language model input unit 250 may input the prompt into the language model according to the determined input timing.

The input timing determination unit 251 may determine the input timing based on pattern information on the user's daily patterns.

The care robot 100 may further include the situation information generator 260 configured to generate situation information of the user's surrounding environment based on the robot-collected information. Furthermore, the input timing determination unit 251 may determine the input timing based on the situation information.

While the care robot 100 inputs a prompt into the language model and receives a response output from the language model, fees or computing resources associated with the use of the language model may be consumed. Accordingly, if the care robot 100 inputs prompts into the language model too frequently, excessive fees or computing resources may be consumed. If the interval of the input timing is set too long, appropriate care services may not be provided in important situations. Therefore, control of prompt input timing may be required as needed.

In an embodiment of the present disclosure, the input timing determination unit 251 may determine the input timing at predetermined intervals. For example, the input timing determination unit 251 may determine that a prompt is to be input into the language model every hour.

In another embodiment of the present disclosure, the input timing determination unit 251 may determine the input timing based on the user's schedule and daily patterns. The input timing determination unit 251 may determine the input timing at predetermined times based on the user's daily patterns. For example, if the user has a pattern of waking up at 7 a.m., the input timing determination unit 251 may determine that the care robot 100 should move to the user's bedroom at that time to assess the situation, generate a prompt, and input it into the language model. As another example, if the user has a pattern of taking medication at 1 p.m., the input timing determination unit 251 may determine that the care robot 100 should move near the user at that time to assess the situation, generate a prompt, and input it into the language model.

In yet another embodiment of the present disclosure, the input timing determination unit 251 may determine the input timing by assessing the situation based on information collected in real time. The care robot 100 may generate a prompt using robot-collected information and IoT-collected information acquired in real time, and may make a primary determination as to whether to input the prompt into the language model. Such primary situation assessment may be performed based on situation information derived by the care robot 100 or on situation information generated by the server using information provided by the care robot 100.

The situation information generator 260 included in the care robot may generate situation information used for determining the input timing of the input timing determination unit 251.

FIG. 12 is a diagram illustrating a process in which the care robot recognizes the user's situation through the situation information generator according to an embodiment of the present disclosure.

Referring to FIG. 12, an care robot 1201 captures an image of the user and generates imaging information 1202. Then, the imaging information 1202 may be input into a space classification model 1203, an object detection model 1204, a pose estimation model 1205, and an action recognition model 1206, and may be processed into element information that includes the result values from each analysis model.

Then, integrated information 1209 is generated by combining the element information, the user's location information 1207, and time information 1208. Thereafter, the integrated information 1209 is input into a situation information generator 1210, which generates situation information 1211 regarding the current situation.

The space classification model 1203, the object detection model 1204, the pose estimation model 1205, and the action recognition model 1206 for generating the integrated information 1209 may receive the imaging information 1202 generated by the camera of the care robot 1201 and provide predetermined outputs. These models may correspond to machine learning or deep learning models trained for graphical processing.

More specifically, the space classification model 1203 may be a model configured to determine what kind of space the user is in based on the imaging information, and may output a class of the space being captured. A known CNN-based classification model may be used as the space classification model. To this end, CNN architectures, such as AlexNet, VGG-16, Inception, ResNet, and MobileNet, may be used.

The object detection model 1204 may output a class of an object being captured based on the imaging information. The object detection model may use a CNN-based classification model to output a bounding box indicating the type and location of the detected object. To this end, CNN architectures, such as AlexNet, VGG-16, Inception, ResNet, and MobileNet, may be used. Representative object detection models may include RCNN, Fast RCNN, YOLO, Single Shot Detector (SSD), Retina-Net, and Pyramid Net.

The pose estimation model 1205 may be a model configured to estimate a pose of the user in an image included in the imaging information. For pose estimation, a CNN-based pose estimation algorithm may be used for 2D or 3D images to estimate 2D/3D pose information. As the pose estimation model, a CNN-based feature point detection model may be applied, and algorithms, such as MoveNet, PoseNet, OpenPose, MediaPipe, AlphaPose, Nuitrack, and Kinecct SDK, may be used. Pose information and the values calculated from it do not change over a short period of time and can be effectively used to identify a tracking target.

The action recognition model 1206 may be a model configured to analyze the type of the user's action based on joint data generated by the pose estimation model 1205. The action recognition model may recognize actions by using the 2D/3D pose information extracted from 2D/3D images by the pose estimation model. In this case, the action recognition model may use a rule-based method, such as a threshold-based method, to classify actions. Alternatively, the action recognition model may use a machine learning-based method, such as a Recurrent Neural Network (RNN), which is a powerful neural network for processing time-series data and suitable for action recognition based on time-series pose information, or a Graph Convolutional Network (GCN), which uses the graph structure of pose data.

That is, the situation information generator 1210 may generate the situation information 1211 about the surroundings of the user by integrating a space class, an object class, a user action, the time information 1208 about the current time, and the location information 1207 about the user's estimated location, all of which are derived from various models based on the imaging information 1202.

Herein, the user's location information 807 may represent information about the user's location on an indoor map generated by the care robot. Herein, the location information may refer to two-dimensional coordinate values relative to a specific point on the indoor map.

As described above, the situation information generator 260 may generate situation information by inputting collected information into a rule-based or machine learning-based model. For example, when a sound of a certain decibel level or more is detected at midnight, the care robot may move to the corresponding location and generate situation information. In another example, when the care robot discovers a person who has fallen while performing security monitoring, the situation information generator 260 may generate related situation information. In yet another example, when the room temperature acquired through the IoT-collected information rises abnormally, the situation information generator 260 may move to the corresponding location and generate situation information.

Referring back to FIG. 2, the service determination unit 270 may determine a care service to be provided to the user based on an output from the language model. The service determination unit 270 may extract, from the output of the language model, text related to available care services, and may determine a care service corresponding to the extracted text. Thereafter, the care robot 100 may provide the determined care service to the user.

After the care robot 100 provides the care service determined by the service determination unit 270 to the user, result information may be uploaded to the server. The result information may include situation information of the user recognized by the care robot 100, information on the care service determined in response to the situation, and feedback information from the user about the care service. The result information may be uploaded to the server or cloud connected to the care robot 100.

After the care robot 100 provides the care service, the feedback information including service suitability or satisfaction may be received from the user through chat, voice conversation, or screen touch. Such feedback information may subsequently be used as training data for generating more appropriate outputs from the language model.

Further, during the process of determining a care service to be provided to the user, the care robot 100 may separately designate information to be uploaded to the server. Among responses output by the language model based on images, important information may be separately extracted, for example, as information to be uploaded to the server. It can be seen from FIG. 11 that the second guide information 1170 designates information to be uploaded to the server as “server upload information.” Thereafter, the care robot 100 may extract, from the response output by the language model, the information marked as “server upload information,” store it separately from the determination of the care service, and upload it to the server.

The above-described method of providing a care service performed by the care robot can be implemented as a computer program stored in a computer-readable storage medium to be executed by a computer or a storage medium including instructions executable by a computer. Also, the above-described method can be implemented as a computer program stored in a computer-readable storage medium to be executed by a computer.

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A care robot, comprising:
at least one sensor;
a memory configured to store instructions; and
a processor operably connected to the memory and configured to execute the instructions,
wherein the processor:
acquires robot-collected information related to a user by using the sensor;
generates a prompt based on the robot-collected information and transmits the generated prompt to a language model;
determine a care service to be provided to the user based on an output received from the language model; and
control components of the care robot to perform the determined care service.

2. The care robot of claim 1,
wherein the sensor is a camera configured to capture an image of the user, and
the processor is configured to analyze sensing information acquired from the camera to generate the robot-collected information.

3. The care robot of claim 2,
wherein the processor is further configured to control at least one of vertical rotation, horizontal rotation, and height adjustment of the camera.

4. The care robot of claim 2,
wherein the processor is further configured to control movements of the care robot to change a capture location of the care robot.

5. The care robot of claim 1,
wherein the care robot:
receives IoT (Internet of Things)-collected information from an IoT device connected thereto; and
generates the prompt based on the robot-collected information and the IoT-collected information.

6. The care robot of claim 1,
wherein the processor:
receives cloud-collected information from a cloud server in which at least one of profile information of the user and pattern information on the user's daily patterns is stored; and
generates the prompt based on the robot-collected information and the cloud-collected information.

7. The care robot of claim 6,
wherein the processor generates an expected activity of the user for the current time as expected pattern information based on activity information including the user's hourly activity history and information about a pattern generation period.

8. The care robot of claim 1,
wherein the processor generates the prompt based on information including a list of available care services.

9. The care robot of claim 8,
wherein the information including a list of available care services further includes information on priorities among the care services, and
the processor determines a care service to be provided to the user based on the output from the language model and the priorities.

10. The care robot of claim 1,
wherein the processor determines an input timing for the prompt to be transmitted to the language model and transmits the prompt at the determined input timing.

11. The care robot of claim 10,
wherein the processor determines the input timing based on pattern information on the user's daily patterns.

12. The care robot of claim 10,
wherein the care robot:
generates situation information about the user's surrounding conditions based on the robot-collected information; and
determines the input timing based on the situation information.
